(19) United States
(12) Patent Application Publication
(10) Pub. No.: US 2026/0254740 A1
(43) Pub. Date: Aug. 27, 2026

(54) Managing Energy Efficient Ethernet Connections for Latency Sensitive Devices

(71) Applicant: Cisco Technology, Inc., San Jose, CA (US)

(72) Inventors: Eric N Johnson, Austin, TX (US); Santosh Prabhakar Bhavsar, Bangalore (IN); Johnston McGaughey, Austin, TX (US)

(21) Appl. No.: 19/060,467

(22) Filed: Feb. 21, 2025

(51) Int. Cl. H04L 43/0852; H04L 41/0833

(52) U.S. Cl. CPC H04L 43/0852; H04L 41/0833

(57) ABSTRACT

Embodiments disclosure herein describe systems, methods, and devices for addressing the challenges of implementing Energy-Efficient Ethernet (EEE) in networks where certain latency-sensitive control protocols are incompatible with EEE or experience degraded performance due to its power-saving mechanisms. Conversely, more devices are being shipped with EEE enabled by default to achieve sustainability-related certifications. In response, various embodiments utilize an EEE management logic that dynamically analyzes network topology data, network traffic data, and EEE settings data to overcome these limitations. By understanding the physical and logical network layout, real-time traffic patterns, and EEE configurations, the system identifies areas where EEE can be safely disabled without negatively affecting critical operations. It can selectively adjust EEE settings to maintain the performance of latency-sensitive protocols while maximizing energy efficiency in less demanding areas. This achieves a desired goal of obtaining reliable operation of latency-sensitive devices, such as industrial control systems, while achieving significant energy savings.

The present disclosure relates to networking. More particularly, the present disclosure relates to managing energy efficient settings on one or more network devices connected to latency-sensitive devices.

### BACKGROUND

Energy Efficient Ethernet (EEE) is a networking technology designed to reduce the power consumption of Ethernet devices during periods of low data activity. Defined by the IEEE 802.3az standard, EEE enables Ethernet interfaces to transition to a low-power idle state when data transmission is minimal or paused, resuming full operation almost instantaneously when needed. This approach optimizes energy use without compromising the network's performance or responsiveness. EEE is particularly beneficial in environments with fluctuating traffic loads, such as data centers, offices, and home networks, where it can help lower operational costs and contribute to overall energy conservation efforts.

Latency-sensitive devices, such as those in industrial motion control systems, rely on real-time, low-latency communication to operate effectively, as delays can disrupt operation. Control loops in machines like robotic arms or CNC systems depend on immediate feedback from sensors and controllers to adjust movements and maintain accuracy. Delays may result in errors such as misalignment or instability, compromising performance and production quality. To address this, these systems often use deterministic communication protocols like EtherCAT or TSN, which prioritize timely data delivery and minimize jitter. High-performance networks, low-latency hardware, and fail-safe mechanisms are essential to ensure reliability and efficiency in these critical operations.

### SUMMARY OF THE DISCLOSURE

Systems and methods for managing energy efficient settings on one or more network devices connected to latency-sensitive devices in accordance with embodiments of the disclosure are described herein. In some embodiments, a device includes a processor, at least one network interface controller configured to provide access to a network via a plurality of ports, and a memory communicatively coupled to the processor, wherein the memory includes an energy efficient ethernet (EEE) management logic. The logic is configured to establish a connection with one or more network devices via the plurality of ports, establish EEE operations with the one or more network devices on at least one port of the plurality of ports, monitor network traffic, determine a connection with a latency-sensitive device, and modify the EEE Operations.

In some embodiments, the latency-sensitive device is a ring network device.

In some embodiments, monitoring the network traffic includes monitoring a control plane protocol for actions related to a latency-sensitive protocol.

In some embodiments, monitoring the network traffic includes watching for link layer discovery protocols.

In some embodiments, monitoring the network traffic includes watching for type/length/value (TLV) traffic.

In some embodiments, the ring network device utilizes one or more control loop protocols.

In some embodiments, the latency-sensitive protocol is a control loop protocol.

In some embodiments, the latency-sensitive protocol is a motion control protocol.

In some embodiments, modifying the EEE operations includes disconnecting from the latency-sensitive device, disabling EEE on the at least one port associated with the latency-sensitive device, and re-establishing the connection with the latency-sensitive device.

In some embodiments, modifying the EEE operations includes selecting one or more time constraints associated with at least one EEE setting, determining at least one threshold of the one or more time constraints, wherein the at least one threshold is configured to restrict EEE from activating, and modifying at least one EEE time constraint at or beyond the determined at least one threshold.

In some embodiments, modifying the EEE operations includes determining when one or more control packets will be transmitted over the connection, and waking the latency-sensitive device prior to the one or more control packets being transmitted.

In some embodiments, modifying the EEE operations includes determining when one or more control packets will be transmitted over the connection, and transmitting dummy traffic to the latency-sensitive device prior to the one or more control packets being transmitted.

In some embodiments, modifying the EEE operations includes generating a notification to a network administrator.

In some embodiments, monitoring the network traffic includes sampling the network traffic.

In some embodiments, a device includes a processor, at least one network interface controller configured to provide access to a network via a plurality of ports, and a memory communicatively coupled to the processor, wherein the memory includes an energy efficient ethernet (EEE) management logic. The logic is configured to monitor a network for changes in topology, determine that an EEE-enabled device has been added to the network, record a connection between the EEE-enabled device and one or more network devices, monitor the connection between the EEE-enabled device and the one or more network devices, determine the connection is with a latency-sensitive network device, and modify at least one EEE operation.

In some embodiments, the connection is associated a plurality of specific network port of the EEE-enabled device.

In some embodiments, modifying the at least one EEE operation includes sending a signal to the EEE-enabled device to disable EEE on a plurality of specific network ports.

In some embodiments, the latency-sensitive network device is associated with a ring network.

In some embodiments, the ring network is configured to utilize at least one control loop.

In some embodiments, a method of managing energy efficient ethernet (EEE) devices on a network, includes establishing a connection with one or more network devices, establishing EEE operations with the one or more network devices, monitoring network traffic, determining a connection with a latency-sensitive network device, and modifying the EEE operations.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a schematic block diagram of a call flow in a power management system, in accordance with various embodiments of the disclosure;

FIG. 3 is a conceptual network diagram of various environments that a EEE management logic may operate on a plurality of network devices, in accordance with various embodiments of the disclosure;

FIG. 4 is a conceptual illustration of an industrial ring network, in accordance with various embodiments of the disclosure;

FIG. 5 is a conceptual illustration of a control loop, in accordance with various embodiments of the disclosure.

FIG. 6 is a flowchart depicting a process for managing energy efficient ethernet settings in accordance with various embodiments of the disclosure;

FIG. 7 is a flowchart depicting a process for managing energy efficient ethernet settings in response to detecting a control group in accordance with various embodiments of the disclosure;

FIG. 8 is a flowchart depicting a process for managing energy efficient ethernet settings in response to deployment on a network in accordance with various embodiments of the disclosure; and

FIG. 9 is a conceptual block diagram of a device suitable for configuration with an energy efficient ethernet management logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

Energy efficient ethernet (EEE) is commonly used to reduce power consumption in networks. Unfortunately, some control protocols, such as those used in industrial settings, are either incompatible with EEE, or EEE can degrade the protocol performance. As those skilled in the art will recognize, industrial motion control and process control networks use control loops (such as digital servos and feed-forward techniques) to run machinery. These control loops often work in 3 steps that are repeated periodically: 1) collect machine state over the network from each input, 2) calculate the next state, and 3) send that new state to each output device or actuator. Often, it's usually desirable to run these three steps as fast as possible. The less time it takes to complete these three steps, the faster the control loop can run, which results in better motion control performance and faster factory production. Thus, from a control loop standpoint it's desirable to reduce network latency. Unfortunately, the need to reduce latency is in direct conflict with requirements to reduce power consumption.

Many regulatory requirements and customer Request for Quotes (RFQs) now-a-days require that EEE be available and enabled by default. One such example is the US EnergyStar standard for Large Network Equipment (LNE). As more sales are requiring US EnergyStar approval, these EEE settings can be set up to degrade certain network performance, such as those in industrial settings. This is due to the fact that EEE works by shutting down the network transmitter during periods of low activity. Any packets that would normally be transmitted during the shutdown are queued. This random variation in packet delay can wreak havoc with control loops. It's even more destructive than typical queuing delay because it's not Quality of Service aware.

In response to the issues described above, devices and methods are discussed herein that can enable compliance with Energy Efficiency standards while still remaining compatible with fast control loops. The embodiments described below advance environmental sustainability goals by allowing EnergyStar certification on certain products that have not heretofore been EnergyStar eligible. This can be done by allowing networking equipment to detect when latency-sensitive devices and protocols are in use, and automatically reconfigure the network to ensure that EEE does not interfere with critical operations.

In some embodiments, a network controller or other device can automatically disable or defeat EEE when a piece of network equipment detects that a latency-sensitive protocol or device is active. As stated above, the EnergyStar standard requires that EEE be enabled by default. But having EEE enabled can interfere with control loops running over the network, and typically requires manual intervention to resolve the conflict. With embodiments of the disclosure described herein, the network equipment monitors traffic running over the network and disables EEEs when a control loop is detected.

Control loops are fundamental mechanisms used in systems to regulate a process by maintaining a desired output despite external disturbances. They often consist of three main components: a plurality of sensors to measure the current state of the system, a controller to compare this measurement against a set target or reference point, and an actuator to make the necessary adjustments. The process operates continuously, with the sensor providing feedback to the controller, which calculates corrective actions based on any deviations and sends signals to the actuator to adjust the system. Control loops can be open-loop, where actions are pre-set without feedback, or closed-loop, where feedback is actively used to refine performance. They are widely used in applications like temperature control in HVAC systems, speed regulation in motors, and maintaining fluid levels in tanks, ensuring stability, efficiency, and precision in various industrial and commercial systems.

Control loops are often associated with ring networks. Ring networks, which are commonly used in industrial settings, are a type of network topology where devices are connected in a circular configuration, with each device linked to two others, forming a closed loop. Data travels in one or both directions around the ring, depending on whether the network is unidirectional or bidirectional, ensuring communication between all devices. This topology is valued for its resilience, as many ring networks include redundancy features that allow the data flow to reroute in the opposite direction if a connection is disrupted, minimizing downtime. Protocols such as Ethernet Ring Protection Switching (ERPS) and Media Redundancy Protocol (MRP) are often used to enhance fault tolerance and recovery times. Ring networks are commonly employed in industrial automation, transportation, and utility systems, where reliable communication and quick recovery from faults are essential to maintaining continuous operation.

Control loop protocol detection can be done in a number of ways. This can include, but is not limited to, software traffic sampling (statistical or random), analyzing NetFlow traffic flow data, watching for packets sent to multicast addresses that are associated with control loop and motion control protocols, monitoring software defined networking (SDN) control plane protocols for actions that relate to control loop and motion control protocols, watching for link layer discovery protocol (LLDP) traffic that relates to control loop and motion control protocols, and/or watching for type/length/value (TLV) traffic that relates to control loop and motion control protocol. These techniques are used to find protocols such as CIP Motion, EtherCat, and Profinet that are active on the network.

Link layer discovery protocol (LLDP) traffic is a network protocol used to advertise and exchange device information between directly connected nodes on a network. Operating at the data link layer (Layer 2), LLDP enables devices such as switches, routers, and servers to share details about their identity, capabilities, and configuration. This information is communicated in the form of structured Type/Length/Value (TLV) data units, which can include details like device name, port descriptions, VLAN assignments, and power-over-Ethernet (PoE) requirements. LLDP traffic is used primarily for network topology discovery, troubleshooting, and management, providing network administrators with a standardized, vendor-neutral method for gaining visibility into connected devices and ensuring efficient network operation.

Type/Length/Value (TLV) traffic is a structured format used in networking to encode and transmit data efficiently. Each TLV element consists of a type field that identifies the kind of information, a length field that specifies the size of the data, and a value field that contains the actual payload. Commonly used in protocols like LLDP, SNMP, and MPLS, TLV structures enable flexible and extensible communication by allowing new types of data to be added without disrupting compatibility. This format ensures efficient parsing and interoperability across systems, making it a reliable method for structured data exchange in networking environments.

In the event that a control loop is detected, embodiments described herein can respond in a variety of ways including, but not limited to, disconnecting from the latency-sensitive device, and subsequently re-establishing the network link with EEE disabled, alter the EEE settings, such as time constraints to ensure that power savings does not become active, explicitly wake both link partners shortly prior to when the latency-sensitive control packets are expected, send dummy traffic preemptively to ensure that the network is not in power saving mode when latency-sensitive control packets are expected, and/or notify the network operator that a latency-sensitive protocol or device is active on a port with EEE enabled. Additionally, when a control loop is detected, the EEE can be automatically disabled on one or more ports where the latency-sensitive protocol is detected, on all ports that are a member of a multicast group that is related to a latency-sensitive protocol, all ports that are a member of a VLAN carrying a latency-sensitive protocol, or all ports on the network equipment.

More specifically, a primary EEE parameter that is relevant for this disclosure is T_{w_sys_tx}. T_{w_sys_tx} is the amount of time between when the system has a packet to transmit, and when it can start sending that packet when the network line is in the lower power idle state (LPI). Currently, the minimum T_{w_sys_tx} is 30 microseconds for 100 BASE-TX (Fast Ethernet), and 16.5 microseconds for 1000 BASE-T (Gigabit Ethernet). As those skilled in the art will recognize, in ring networks, this issue multiplies as the packets need to be sent over multiple devices in the ring. For customers in industries that utilize such configurations, delays of just 12 microseconds can be a problem that requires correction, such as impairing control loop performance.

It should also be noted that currently, there is no single detection mechanism that works for all latency-sensitive protocols such as those utilized by industrial motion controls. For example, EthernetI/P can be detected by IP Access Control Lists (ACLs) on the switch to sample relevant packets for further analysis by software, Profinet devices commonly use LLDP for discovery, and many ethernet switches already participate in LLDP, and EtherCAT can be detected by MAC Access Control Lists because it uses a Unique EtherType. Previous attempts to address this problem have focused on observing packet timing, looking for patterns, and scheduling wake and sleep patterns for that specific transmitter based on self-similar traffic patterns. However, embodiments of the disclosure described herein do not depend on packet timing and instead uses protocol and application awareness to control EEE behavior, and to disable it when appropriate. Furthermore, embodiments herein can also control EEE in both directions of a link, which is not possible with the egress scheduling approach traditionally done.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

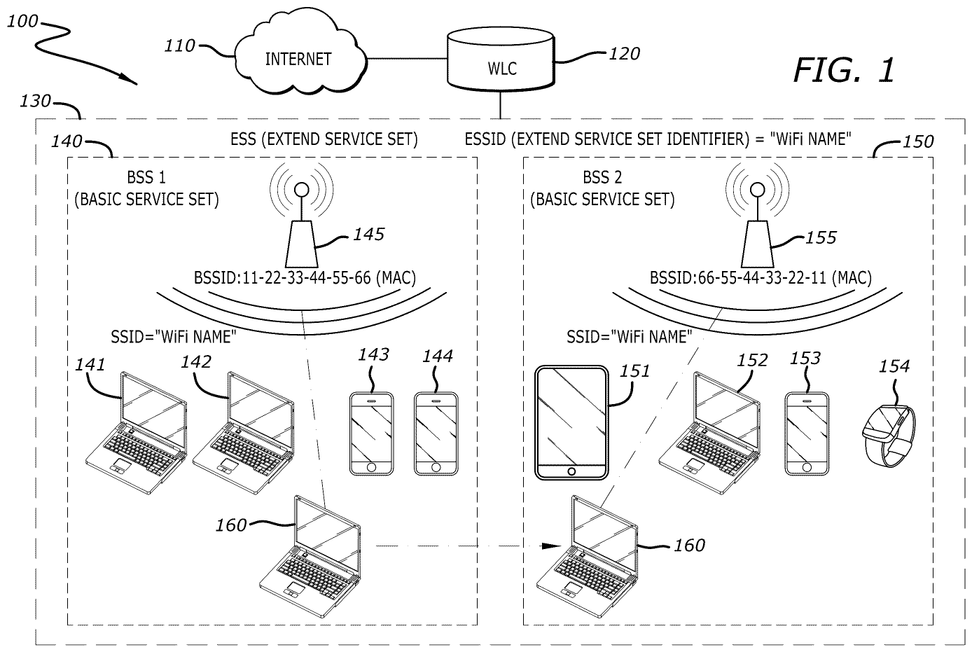

Referring to FIG. 1, a schematic block diagram of a wireless local networking system 100, in accordance with various embodiments of the disclosure is shown. Wireless local networking standards play a crucial role in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes—comprising devices like laptops, smartphones, or other Wi-Fi-enabled devices—operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

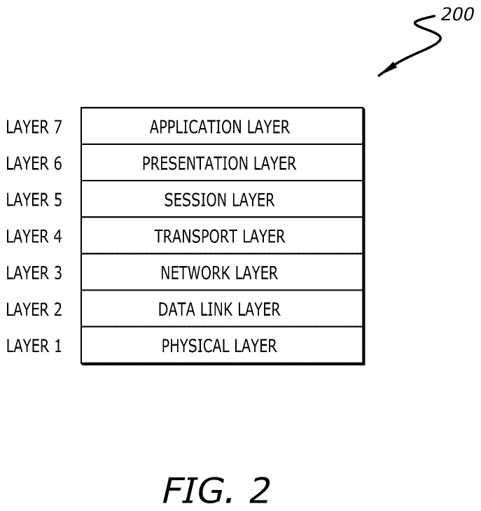

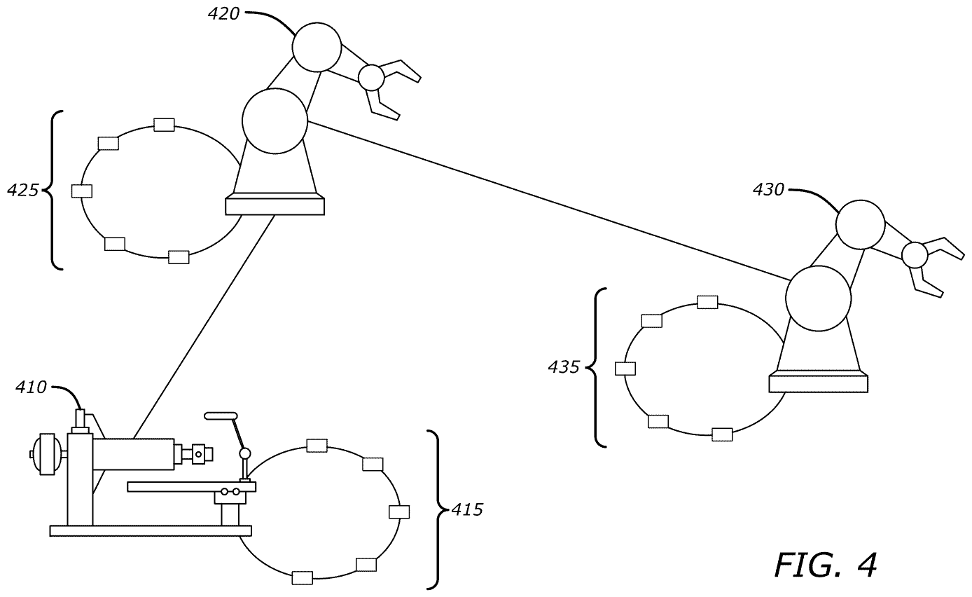

The network can include a variety of user end devices that connect to the network. These devices can sometimes be referred to as stations (i.e., “STAs”). Each device is typically configured with a medium access control (“MAC”) address in accordance with the IEEE 802.11 standard. As described in more detail in FIG. 2, a physical layer can also be configured to communicate over the wireless medium. As described in more detail of FIG. 4, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “Wi-Fi Name”, which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network utilizes a second access point 155 and comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

Latency-sensitive devices connect to and interact with other network devices through protocols and configurations designed to prioritize real-time data transmission. Protocols like Time-Sensitive Networking (TSN) and IEEE 802.1Qav ensure deterministic communication by allocating bandwidth and scheduling packets to meet strict timing requirements. Features such as Quality of Service (QoS) and traffic shaping help prioritize data from these devices, ensuring that critical information is transmitted without delay. Network infrastructure, including low-latency switches and routers, supports these capabilities by minimizing jitter and delay across connections. In complex networks, dedicated pathways or VLANs may be used to isolate and protect latency-sensitive traffic, ensuring reliable communication for applications like industrial automation, robotics, and precision controls. However, as discussed above, connecting to EEE-enabled network devices can be problematic for maintaining a satisfactory latency time.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices within a totally or partially wired ethernet system. The elements depicted in FIG. 1 may also be interchangeable with other elements of FIGS. 2-9 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In various embodiments, the communication for latency-sensitive devices typically occurs on the data link layer (Layer 2) and the network layer (Layer 3) of the OSI model. At the data link layer, protocols like Ethernet and enhancements such as Time-Sensitive Networking (TSN) operate to provide deterministic delivery, low latency, and prioritization of traffic through mechanisms like Quality of Service (QoS) and traffic shaping. TSN, for example, works within Ethernet to allocate specific time slots and prioritize frames for time-critical data. At the network layer, protocols such as IP enable routing of packets between devices across different networks, while ensuring that latency-sensitive packets are given priority through mechanisms like Differentiated Services Code Point (DSCP) tagging. These layers work together to establish a reliable communication path that meets the timing requirements of real-time applications.

In additional embodiments, the fourth transport layer, can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer, can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. Furthermore, mechanisms to detect latency-sensitive traffic/signals can occur at any of the OSI layers described in FIG. 2. The elements depicted in FIG. 2 may also be interchangeable with other elements of FIG. 1 and FIGS. 3-9 as required to realize a particularly desired embodiment.

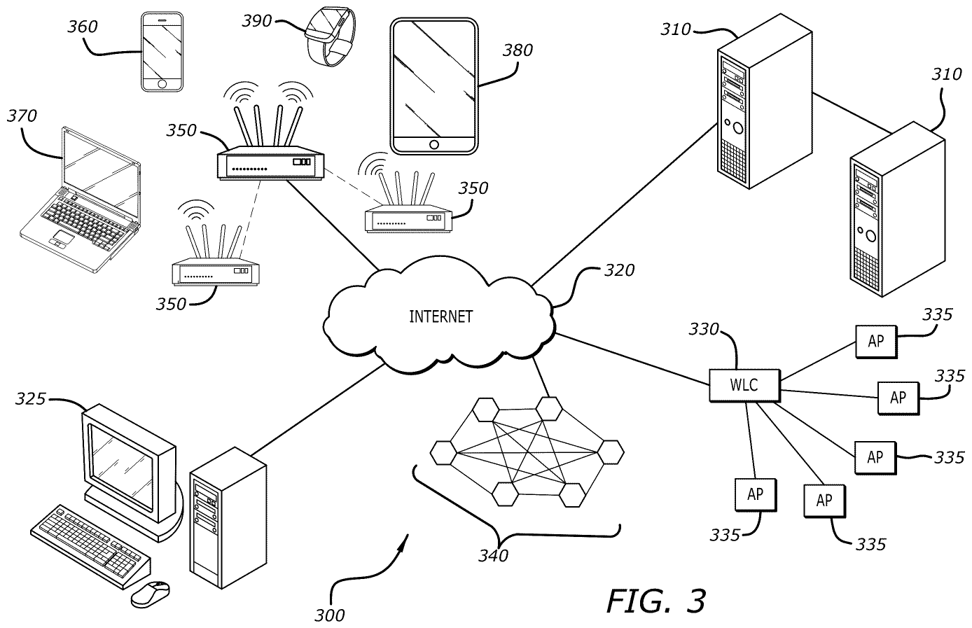

Referring to FIG. 3, a conceptual network diagram 300 of various environments that an energy efficient ethernet (EEE) management logic may operate on a plurality of network devices, in accordance with various embodiments of the disclosure is shown. Those skilled in the art will recognize that the EEE management logic can include various hardware and/or software deployments and can be configured in a variety of ways. In many embodiments, the EEE management logic can be configured as a standalone device, exist as a logic in another network device, be distributed among various network devices operating in tandem, or remotely operated as part of a cloud-based network management tool. In further embodiments, one or more servers 310 can be configured with the EEE management logic or can otherwise operate as the EEE management logic. In many embodiments, the EEE management logic may operate on one or more servers 310 connected to a communication network 320 (shown as the “Internet”). The communication network 320 can include wired networks or wireless networks. The EEE management logic can be provided as a cloud-based service that can service remote networks, such as, but not limited to a deployed network 340.

However, in additional embodiments, the EEE management logic may be operated as a distributed logic across multiple network devices. In the embodiment depicted in FIG. 3, a plurality of network access points (APs) 350 can operate as the EEE management logic in a distributed manner or may have one specific device operate as the EEE management logic for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the EEE management logic may be integrated within another network device. In the embodiment depicted in FIG. 3, a wireless LAN controller (WLC) 330 may have an integrated EEE management logic that the WLC 330 can use to monitor or control power consumption of the APs 335 that the WLC 330 is connected to, either wired or wirelessly. In still more embodiments, a personal computer 325 may be utilized to access and/or manage various aspects of the EEE management logic, either remotely or within the network itself. In the embodiment depicted in FIG. 3, the personal computer 325 communicates over the communication network 320 and can access the EEE management logic of the servers 310, or the network APs 350, or the WLC 330.

Although a specific embodiment for various environments that an EEE management logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the EEE management logic may be provided as a device or software separate from the WLC 330 or the EEE management logic may be integrated into the WLC 330. The elements depicted in FIG. 3 may also be interchangeable with other elements of FIGS. 1-2 and FIGS. 4-9 as required to realize a particularly desired embodiment.

Referring to FIG. 4, a conceptual illustration of an industrial ring network, in accordance with various embodiments of the disclosure is shown. As those skilled in the art will recognize, various settings may comprise one or more ring networks. In the embodiment depicted in FIG. 4, a series of industrial machines that utilize ring networks are shown in communication with each other. Specifically, there is a lathe machine 410 that has a lathe associated ring network 415, a first robotic arm 420 that has a first associated ring network 425, and a second robotic arm 430 that has a second associated ring network 435.

Ring networks are a commonly used topology in industrial automation settings. In such a setup, the ring network can ensure reliable and low-latency communication between the robotic arm's control systems and associated devices, such as controllers, sensors, and actuators. Each device in the ring is connected to two others, forming a continuous loop that allows data to flow in either direction. This redundancy is critical because it enables the network to reroute data in the opposite direction if a link fails, ensuring uninterrupted operation of the robotic arm.

For many industrial devices, such as for a robotic arm, this ring network supports real-time communication needed for precise movements and adjustments. Sensors on the arm transmit data, such as position, speed, or torque, to the controller through the network, while the controller sends corresponding commands to the actuators. Protocols like media redundancy protocol (MRP) or ethernet ring protection switching (ERPS) are often used to manage the network's fault tolerance and maintain high-speed, deterministic communication. This topology enhances the system's reliability, making it ideal for demanding applications where downtime or delays can significantly impact productivity or safety.

As such, having a low latency data transfer is critical for ring networks and machines like robotic arms because these systems rely on real-time data exchange to ensure precision and efficiency. Any delay in communication between sensors, controllers, and actuators can disrupt the synchronization of movements, resulting in errors, reduced accuracy, or instability in the machine's operation. In a ring network, low-latency protocols and optimized routing ensure that commands and feedback are transmitted quickly, enabling the system to respond immediately to changes or disturbances. This is essential in applications where split-second timing is required to maintain safety, productivity, and precision.

Low latency communication can also be critical for ring networks in a lathe machine 410 because these systems require precise and immediate feedback to control the cutting process accurately. The sensors on the lathe continuously monitor parameters like spindle speed, tool position, and material resistance, transmitting data to the controller in real time. Any delay in this communication can lead to improper adjustments, resulting in defects, reduced tolerances, or even damage to the workpiece or tool. A low-latency ring network ensures that commands and feedback loop seamlessly, allowing the machine to maintain optimal performance, precision, and safety during high-speed operations.

Although a specific embodiment for an industrial ring network suitable for carrying out the various steps, processes, methods, and operations described herein is discussed with respect to FIG. 4, any of a variety of systems and/or processes may be utilized in accordance with embodiments of the disclosure. For example, the specific devices and connection layout can vary depending on the specific installation or application desired. The elements depicted in FIG. 4 may also be interchangeable with other elements of FIGS. 1-3 and FIGS. 5-9 as required to realize a particularly desired embodiment.

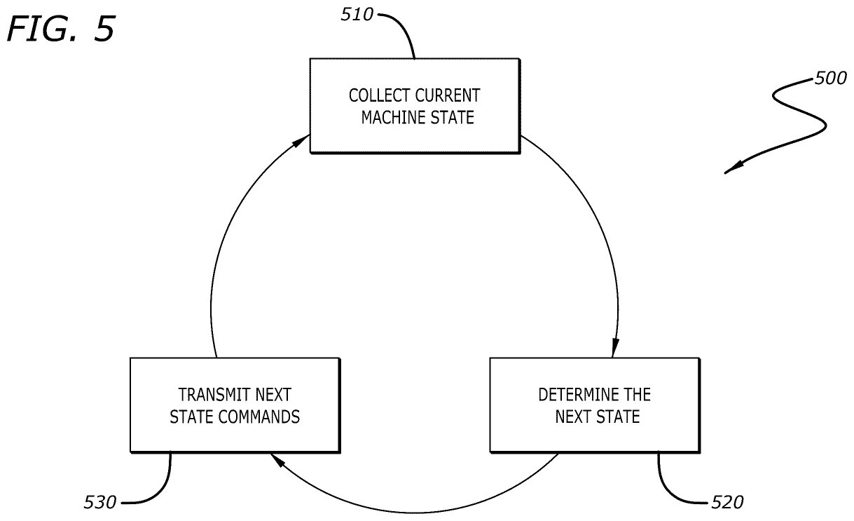

Referring to FIG. 5, a conceptual illustration of a control loop 500, in accordance with various embodiments of the disclosure is shown. As previously described, control loops are systems that continuously monitor, evaluate, and adjust a process to maintain a desired output. Sensors can collect real-time data, which is analyzed by a controller to determine corrective actions based on deviations from a target state. These adjustments are often implemented through actuators, creating a feedback loop that ensures precision and stability in dynamic systems like industrial machinery or robotics.

This embodiment depicted in FIG. 5 conceptually illustrates a control loop 500, comprising a cyclic process where the machine's state is continuously monitored, analyzed, and adjusted to achieve desired performance. In many embodiments, the control loop can start with the step labeled “Collect Current Machine State” 510, where sensors can gather real-time data from the machine. This data typically includes key parameters such as position, speed, temperature, or force, depending on the system's purpose. Accurate and timely collection of this information is crucial, as it serves as the foundation for subsequent decisions and actions within the loop.

In various embodiments, the second stage, “Determine the Next State” 520, can involve processing the collected data to evaluate the current machine condition and compare it to the desired target state. A controller can interpret the data using predefined algorithms, control logic, or models to decide the corrective actions necessary to bring the machine closer to the intended operation parameters. This stage can be utilized for ensuring precision and stability, as it defines how the system responds to changes or disturbances.

In the final stage, “Transmit Next State Commands” 530, certain embodiments can calculate the adjustments which are sent to actuators or other machine components to modify the system's behavior. These commands may involve altering motor speeds, adjusting valve positions, or modifying other control elements. Once the adjustments are implemented, the loop cycles back to collecting the updated machine state, ensuring continuous monitoring and refinement. This closed-loop approach enables the system to maintain high accuracy and adaptability, making it ideal for applications in robotics, industrial machinery, and other dynamic systems.

As such, control loops typically require low-latency data transmission to ensure real-time responsiveness and precision in maintaining the desired system state. Sensors can continuously collect data, which must be quickly transmitted to the controller for immediate analysis and decision-making. Any delays in this process can disrupt the timing of corrective actions, leading to errors, instability, or inefficiency in the system. For example, in applications like robotics or industrial machinery, even slight delays can result in misaligned movements or production defects. Low-latency communication can ensure that the feedback loop operates seamlessly, allowing the system to react instantly to changes or disturbances and maintain optimal performance.

Although a specific embodiment for a control loop suitable for carrying out the various steps, processes, methods, and operations described herein is discussed with respect to FIG. 5, any of a variety of systems and/or processes may be utilized in accordance with embodiments of the disclosure. For example, those skilled in the art will recognize that the specific layout, connection, arrangement, and/or selection of the control loop can vary from deployment to deployment based on the needs of the desired application. The elements depicted in FIG. 5 may also be interchangeable with other elements of FIGS. 1-4 and FIGS. 6-9 as required to realize a particularly desired embodiment.

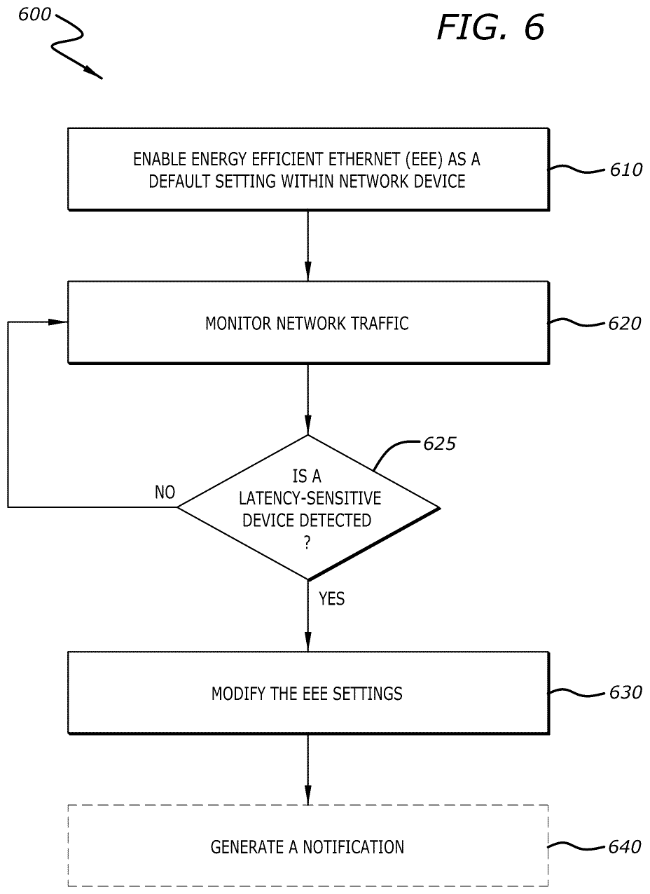

Referring to FIG. 6, a flowchart depicting a process 600 for managing energy efficient ethernet settings in accordance with various embodiments of the disclosure is shown. In many embodiments, the process 600 can enable energy efficient ethernet (EEE) as a default setting within a network device (block 610). As previously discussed, this can be done to garner an energy efficiency rating such as an EnergyStar certification, which require new network devices to ship with EEE enabled. In some embodiments, the EEE may be turned back on and restart this process over.

In more embodiments, the process 600 can monitor network traffic (block 620). This monitoring can involve using tools to capture and analyze data packets in real time, identifying patterns or anomalies in traffic flow. By setting thresholds for key metrics like bandwidth usage and latency, the system can generate alerts when performance deviates from expected norms. Additionally, traffic monitoring can include filtering by protocol or device type to pinpoint issues specific to IoT devices and ensure efficient data communication across the network. These types of filters are discussed in more detail above.

In additional embodiments, the process 600 can determine if a latency-sensitive device is detected (block 625). As previously discussed, this can involve software traffic sampling (statistical or random), analyzing NetFlow traffic flow data, watching for packets sent to multicast addresses that are associated with control loop and motion control protocols, monitoring software defined networking (SDN) control plane protocols for actions that relate to control loop and motion control protocols, watching for link layer discovery protocol (LLDP) traffic that relates to control loop and motion control protocols, and/or watching for type/length/value (TLV) traffic that relates to control loop and motion control protocol. These techniques are used to find protocols such as CIP Motion, EtherCat, and Profinet that are active on the network.

If a latency sensitive device is not detected, the process 600 can continue to monitor the network traffic (block 620). However, if a latency-sensitive device is detected, the process 600 can modify the EEE settings (block 630). To modify EEE settings in a system, the process 600 may access a network device's configuration interface (e.g., NIC or managed switch) and navigate to the “Energy-Efficient Ethernet” or “Power Management” section. Enable or disable EEE based on the performance needs of IoT devices, adjusting idle timing to balance power savings with responsiveness for latency-sensitive applications. Apply and test the changes while using monitoring tools to ensure optimal performance and power efficiency across the network.

In certain optional embodiments, the process 600 can generate a notification (block 640). While a number of embodiments may automatically modify the EEE settings, there are some embodiments, where a notification can be generated to a network administrator to indicate that the EEE settings should be disabled. However, it is contemplated that various embodiments will automatically disable or otherwise modify the EEE settings in a sustainably positive way without the need for human intervention. Generating the notification can be configured to inform a user or network administrator after these modifications have occurred, if at all.

Although a specific embodiment for a process 600 for managing energy efficient ethernet settings suitable for carrying out the various steps, processes, methods, and operations described herein is discussed with respect to FIG. 6, any of a variety of systems and/or processes may be utilized in accordance with embodiments of the disclosure. Additionally, the use of optional embodiments does not indicate that the remaining elements are non-optional, but is presented to highlight a separate embodiment and/or to indicate when a decision may be made to not utilize this element, etc. The elements depicted in FIG. 6 may also be interchangeable with other elements of FIGS. 1-5 and FIGS. 7-9 as required to realize a particularly desired embodiment.

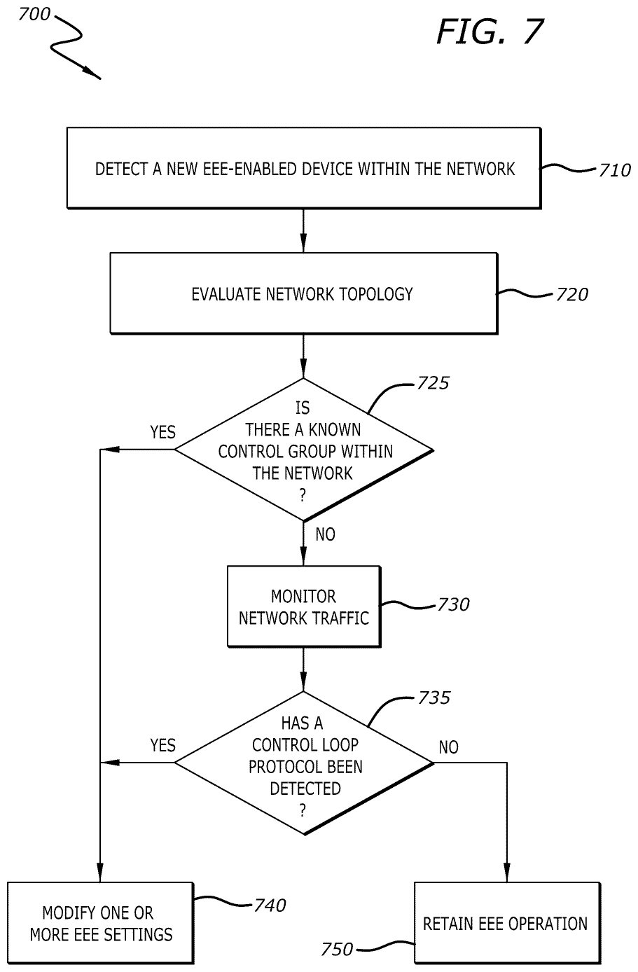

Referring to FIG. 7, a flowchart depicting a process 700 for managing energy efficient ethernet settings in response to detecting a control group in accordance with various embodiments of the disclosure is shown. In many embodiments, the process 700 can detect a new EEE-enabled device within the network (block 710). EEE-enabled devices can be detected in some embodiments by utilizing network discovery protocols like LLDP or SNMP can identify connected devices and their features, including EEE support. Managed switches or routers often log new device connections, which can be monitored for EEE-specific capabilities. Tools that analyze power consumption or capture broadcast traffic, such as ARP requests or DHCP discovery messages, may also reveal the presence of an EEE-enabled device. Advanced network management systems can combine these methods to provide a comprehensive view of newly added devices and their capabilities. In various embodiments, the process 700 can record or otherwise store the connection occurring between the EEE-enabled device and the one or more network devices connected to it.

In a number of embodiments, the process 700 can evaluate a network topology (block 720). To evaluate a network topology after adding a new device, a mapping of the updated network layout can occur, identifying how the new device connects and interacts with existing components. In some embodiments, the process 700 can analyze the potential impact on bandwidth, latency, and overall traffic flow, ensuring that the device does not introduce bottlenecks or disrupt critical pathways. In some embodiments, the process 700 can assess the device's compatibility with the network protocols, addressing security concerns like unauthorized access or potential vulnerabilities.

In more embodiments, the process 700 can determine if there is a known control-group within the network (block 725). In the context of control loops and ring networks, a control group can refer to a set of devices or systems organized to function together under a common control mechanism. In control loops, it can include sensors, controllers, and actuators working to maintain desired states, such as temperature or pressure. In ring networks, it may involve nodes managing traffic and redundancy, like rerouting during link failures. Control groups enable cohesive operation, whether by stabilizing processes or ensuring efficient and fault-tolerant network performance.

If it is determined that a known control-group is present, then the process can directly modify the one or more EEE settings that are enabled on the new device (block 740). However, if no known control group is known, then the process 700 can, in additional embodiments, monitor the network traffic (block 730). As previously discussed, this monitoring can involve using tools to capture and analyze data packets in real time, identifying patterns or anomalies in traffic flow. By setting thresholds for key metrics like bandwidth usage and latency, the system can generate alerts when performance deviates from expected norms. Additionally, traffic monitoring can include filtering by protocol or device type to pinpoint issues specific to IoT devices and ensure efficient data communication across the network. These types of filters are discussed in more detail above.

In further embodiments, the process 700 can determine if a control loop protocol has been detected (block 735). In some embodiments, the determination may be for detecting a motion control protocol. In yet further embodiments, the determination can be for detecting one or more latency-sensitive protocols more generally. If it is determined that a control loop (or other latency-sensitive protocol) is detected, then the process can modify one or more EEE settings (block 740). However, if it is determined that no control loop, motion control, or other latency-sensitive protocol is detected, then the process 700 can in various embodiments, retain the EEE operation within the network device (block 750).

Although a specific embodiment for a process 700 for modifying a flow classification suitable for carrying out the various steps, processes, methods, and operations described herein is discussed with respect to FIG. 7, any of a variety of systems and/or processes may be utilized in accordance with embodiments of the disclosure. For example, the process 700 can conduct the detection in response to an event indicating that a new network device has been added to the network, or may be configured to attempt detection after a certain time interval. The elements depicted in FIG. 7 may also be interchangeable with other elements of FIGS. 1-6 and FIGS. 8-9 as required to realize a particularly desired embodiment.

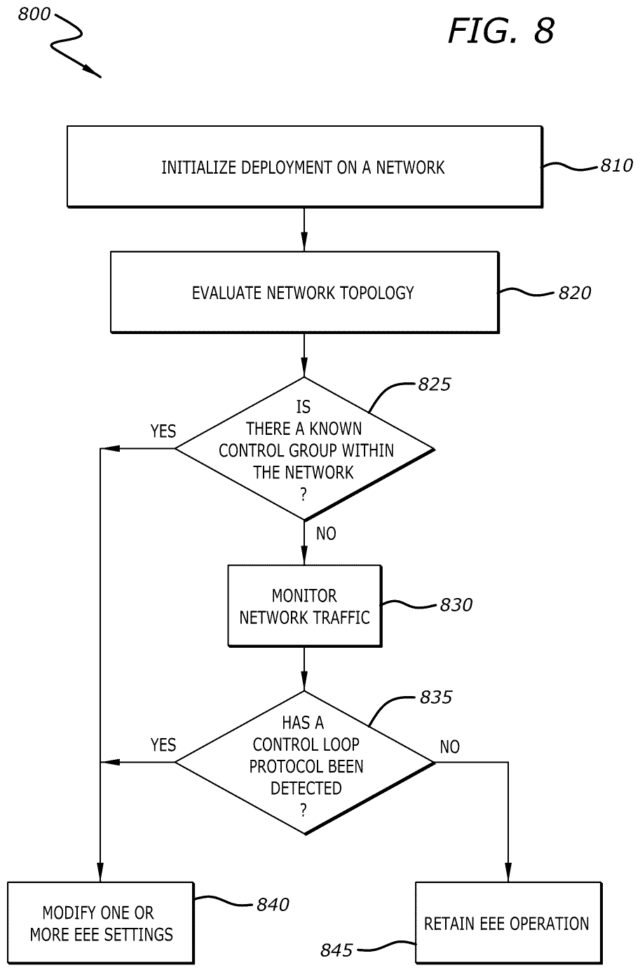

Referring to FIG. 8, a flowchart depicting a process for managing energy efficient ethernet settings in response to deployment on a network in accordance with various embodiments of the disclosure is shown. In many embodiments, the process 800 can initialize deployment on a network (block 810). As opposed to the embodiment of a process in FIG. 7 where a monitoring device is already established on a network and a new EEE-enabled device is added, the process 800 depicted in FIG. 8 instead shows how a monitoring device or process may work when it is coming into one or more networks that may already have established EEE-enabled devices.

In a number of embodiments, the process 800 can evaluate a network topology (block 820). To evaluate a network topology after adding a new device, a mapping of the updated network layout can occur, identifying how the new device connects and interacts with existing components. In some embodiments, the process 800 can analyze the potential impact on bandwidth, latency, and overall traffic flow, ensuring that the device does not introduce bottlenecks or disrupt critical pathways. In some embodiments, the process 800 can assess the device's compatibility with the network protocols, addressing security concerns like unauthorized access or potential vulnerabilities.

In more embodiments, the process 800 can determine if there is a known control-group within the network (block 825). In the context of control loops and ring networks, a control group can refer to a set of devices or systems organized to function together under a common control mechanism. In control loops, it can include sensors, controllers, and actuators working to maintain desired states, such as temperature or pressure. In ring networks, it may involve nodes managing traffic and redundancy, like rerouting during link failures. Control groups enable cohesive operation, whether by stabilizing processes or ensuring efficient and fault-tolerant network performance.

If it is determined that a known control-group is present, then the process can directly modify the one or more EEE settings that are enabled on the new device (block 840). However, if no known control group is known, then the process 800 can, in additional embodiments, monitor the network traffic (block 830). As previously discussed, this monitoring can involve using tools to capture and analyze data packets in real time, identifying patterns or anomalies in traffic flow. By setting thresholds for key metrics like bandwidth usage and latency, the system can generate alerts when performance deviates from expected norms. Additionally, traffic monitoring can include filtering by protocol or device type to pinpoint issues specific to IoT devices and ensure efficient data communication across the network. These types of filters are discussed in more detail above.

In further embodiments, the process 800 can determine if a control loop protocol has been detected (block 835). In some embodiments, the determination may be for detecting a motion control protocol. In yet further embodiments, the determination can be for detecting one or more latency-sensitive protocols more generally. If it is determined that a control loop (or other latency-sensitive protocol) is detected, then the process can modify one or more EEE settings (block 840). This modification can be done to any existing devices on the network that have EEE-enabled. In response, the process 800 may, in certain embodiments, require one or more supplemental adjustments, notifications, or steps to configure the latency-sensitive devices to begin operating at optimal speed again now that EEE is disabled. However, if it is determined that no control loop, motion control, or other latency-sensitive protocol is detected, then the process 800 can in various embodiments, retain the EEE operation within the network device (block 845). In these embodiments, the process 800 can revert to a process similar to the one depicted in FIG. 7 wherein the network is subsequently monitored for additional network devices being added that have EEE enabled.

Although a specific embodiment for a process 800 for receiving a modified flow classification suitable for carrying out the various steps, processes, methods, and operations described herein is discussed with respect to FIG. 8, any of a variety of systems and/or processes may be utilized in accordance with embodiments of the disclosure. For example, the process 800 can conduct this step upon initialization or in response to one or more prompts from another system or a network administrator. The elements depicted in FIG. 8 may also be interchangeable with other elements of FIGS. 1-7 and 9 as required to realize a particularly desired embodiment.

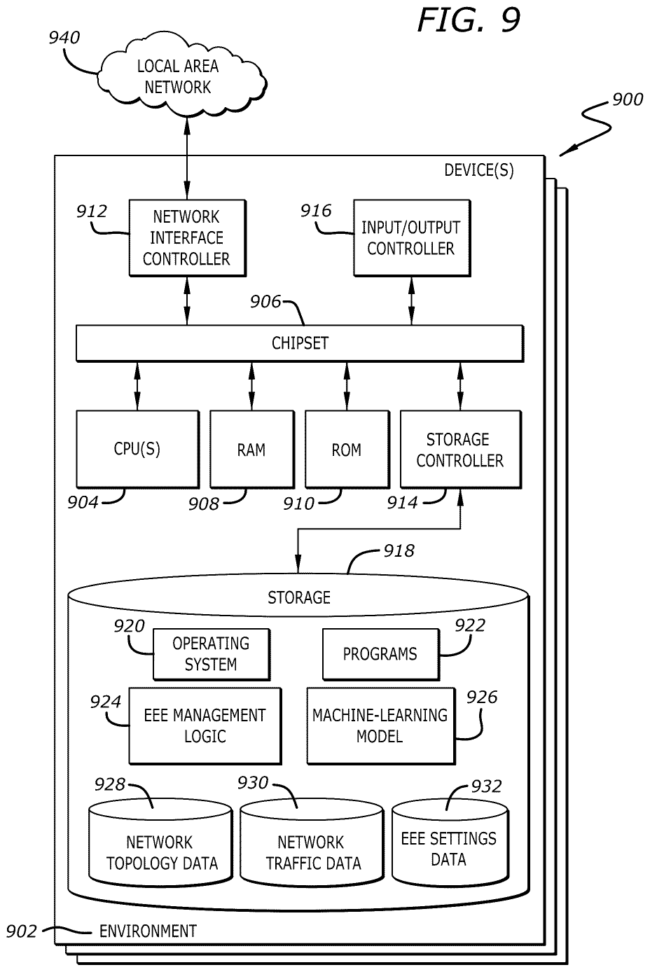

Referring to FIG. 9, a conceptual block diagram of a device suitable for configuration with a EEE management logic, in accordance with various embodiments of the disclosure is shown. The embodiment of the conceptual block diagram depicted in FIG. 9 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In many further embodiments, the device 900 may include a EEE management logic 924. The EEE management logic 924 can be configured to perform one or more of the various steps, processes, operations, and/or other methods that are described above. Often, the EEE management logic 924 can be a set of instructions stored within a non-volatile memory that, when executed by the controller(s)/processor(s) 904 can carry out these steps, etc. In some embodiments, the EEE management logic 924 may be a client application that resides on a network-connected device, such as, but not limited to, a server, switch, personal or mobile computing device in a single or distributed arrangement.

Specifically, The EEE management logic 924 may dynamically optimize the energy efficiency of the network by analyzing real-time data and adjusting settings to balance power consumption with performance demands. It may evaluate network topology data 928 to understand device connectivity and identify areas where energy-saving measures can be applied without disrupting traffic flow. Simultaneously, it could leverage network traffic data 930 to monitor usage patterns and dynamically enable or disable EEE features, such as transitioning links to low-power states during periods of inactivity or as outlined above with reference to the embodiments described in the discussion of FIGS. 6-8. Additionally, the logic may utilize EEE settings data 932 to fine-tune configurations, ensuring compatibility with connected devices and aligning adjustments with system requirements.

In various embodiments, network topology data 928 may include information such as the arrangement of network nodes, the physical and logical connections between them, the types of devices present, and the pathways through which data is transmitted. By utilizing network topology data, the system can identify bottlenecks, redundancies, or critical points that could impact energy efficiency and performance. For example, the data can help determine which links or devices are most active, enabling the logic to apply energy-efficient settings selectively without compromising critical traffic flows. Additionally, topology data may include metadata about device roles and capabilities, such as whether specific switches or interfaces support Energy-Efficient Ethernet (EEE) protocols, further enhancing the system's ability to make informed, dynamic adjustments.

In further embodiments, network traffic data 930 can provide critical insights into the flow and characteristics of data within a network, serving as a foundation for optimizing performance and implementing energy-efficient solutions like those managed by the EEE management logic 924. This data typically comprises telemetry information, including packet counts, throughput, latency, and jitter measurements, which indicate the speed and reliability of data transmission. It may also include details about traffic patterns, such as peak usage times, source and destination addresses, and protocol types, helping to identify high-demand areas or specific applications that dominate bandwidth consumption.

By analyzing network traffic data, the system can dynamically adjust EEE settings to balance power efficiency and performance. For example, it can identify periods of low activity to transition interfaces or devices into low-power states, while ensuring critical data flows remain uninterrupted during peak times. Additionally, traffic data can detect anomalies, such as unexpected spikes or irregular patterns, which may signal security concerns or network misconfigurations. This comprehensive view of traffic behavior enables the EEE management logic 924 to optimize energy use without compromising the network's responsiveness or reliability for latency-sensitive devices.

In a number of embodiments, EEE settings data 932 may comprise the configuration parameters and operational states related to the implementation of Energy-Efficient Ethernet within a network. This data may include settings such as whether EEE is enabled or disabled on specific interfaces, the idle timers that determine when links enter low-power states, and thresholds for transitioning back to full-power operation. It may also track the compatibility of connected devices and switches with EEE standards, as well as historical usage data to evaluate how effectively the settings balance energy efficiency and performance.

In many embodiments, EEE settings data 932 can be utilized by the EEE management logic 924 to make informed decisions when adjusting or optimizing the system's energy efficiency. By referencing these settings, the system can fine-tune power-saving measures based on real-time network conditions, such as reducing energy consumption during low-traffic periods without impacting critical operations. Additionally, this data supports diagnostics and troubleshooting by providing visibility into how EEE adjustments correlate with network performance, enabling targeted interventions to address any inefficiencies or issues.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926.

The ML model(s) 926 can be configured to generate inferences to make predictions or draw conclusions from data. An inference can be considered the output of a process of applying a model to new data. This can occur by learning from at least the network topology data 928, the network traffic data 930, and the EEE settings data 932. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

ML model(s) 926 can, in many embodiments, extract relevant features from network traffic data, such as packet size, inter-arrival times, protocol types, port numbers, and statistical properties of the traffic. These features can serve as the basis for characterizing different types of traffic and capturing the underlying patterns and behaviors within the network. ML model(s) 926 can be used for traffic classification tasks, particularly when labeled datasets are available. These algorithms can learn to recognize patterns and relationships between features and traffic classes by training on labeled traffic data. For example, decision trees, random forests, support vector machines (SVM), and neural networks are popular choices for supervised learning in traffic classification. By leveraging labeled data, these algorithms can accurately classify incoming traffic into predefined categories, such as VoIP, video streaming, or web browsing.

Unsupervised learning techniques are valuable when labeled data is scarce or unavailable. Clustering algorithms, such as k-means clustering or hierarchical clustering, can group similar traffic flows together based on their feature representations. These clusters can then be analyzed to identify different types of traffic or anomalous behavior within the network. Unsupervised learning provides a data-driven approach to traffic classification, allowing network administrators to discover hidden patterns and structures within the traffic data.

Deep learning models, including convolutional neural networks (CNNs) and recurrent neural networks (RNNs), have demonstrated impressive performance in traffic classification tasks. CNNs can automatically learn hierarchical representations of traffic features, while RNNs can capture temporal dependencies in sequential data, such as packet traces or session logs. These deep learning architectures excel at handling complex, high-dimensional traffic data and can adaptively learn from large-scale datasets to improve classification accuracy.

In certain embodiments the ML models(s) 926 can be combined into multiple ML models 926 to enhance classification performance. By aggregating predictions from diverse classifiers or feature subsets, ensemble methods can mitigate the limitations of individual models and improve generalization across different traffic scenarios. These can provide a robust and scalable approach to traffic classification, particularly in dynamic network environments where traffic patterns evolve over time.

The use of ML model(s) 926 are often desired for continuous adaptation and real-time classification in dynamic network environments. These processes can update classification models incrementally as new traffic data arrives, ensuring that the models remain up-to-date and effective in classifying emerging traffic patterns. This can enable adaptive traffic classification solutions that can quickly respond to changes in network conditions and evolving traffic patterns.

Although a specific embodiment for a device suitable for configuration with the EEE management logic for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or APs. The elements depicted in FIG. 9 may also be interchangeable with other elements of FIGS. 1-8 as required to realize a particularly desired embodiment.

Finally, although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network via a plurality of ports; and
a memory communicatively coupled to the processor, wherein the memory comprises an energy efficient ethernet (EEE) management logic that is configured to:
establish a connection with one or more network devices via the plurality of ports;
establish EEE operations with the one or more network devices on at least one port of the plurality of ports;
monitor network traffic;
determine a connection with a latency-sensitive device; and
modify the EEE Operations.

2. The device of claim 1, wherein the latency-sensitive device is a ring network device.

3. The device of claim 2, wherein monitoring the network traffic comprises monitoring a control plane protocol for actions related to a latency-sensitive protocol.

4. The device of claim 2, wherein monitoring the network traffic comprises watching for link layer discovery protocols.

5. The device of claim 2, wherein monitoring the network traffic comprises watching for type/length/value (TLV) traffic.

6. The device of claim 2, wherein the ring network device utilizes one or more control loop protocols.

7. The device of claim 3, wherein the latency-sensitive protocol is a control loop protocol.

8. The device of claim 3, wherein the latency-sensitive protocol is a motion control protocol.

9. The device of claim 1, wherein modifying the EEE operations comprises:
disconnecting from the latency-sensitive device;
disabling EEE on the at least one port associated with the latency-sensitive device; and
re-establishing the connection with the latency-sensitive device.

10. The device of claim 1 wherein modifying the EEE operations comprises:
selecting one or more time constraints associated with at least one EEE setting;
determining at least one threshold of the one or more time constraints, wherein the at least one threshold is configured to restrict EEE from activating; and
modifying at least one EEE time constraint at or beyond the determined at least one threshold.

11. The device of claim 1, wherein modifying the EEE operations comprises:
determining when one or more control packets will be transmitted over the connection; and
waking the latency-sensitive device prior to the one or more control packets being transmitted.

12. The device of claim 1, wherein modifying the EEE operations comprises:
determining when one or more control packets will be transmitted over the connection; and
transmitting dummy traffic to the latency-sensitive device prior to the one or more control packets being transmitted.

13. The device of claim 1, wherein modifying the EEE operations comprises generating a notification to a network administrator.

14. The device of claim 1 wherein monitoring the network traffic comprises sampling the network traffic.

15. A device, comprising:
a processor;
at least one network interface controller configured to provide access to a network via a plurality of ports; and
a memory communicatively coupled to the processor, wherein the memory comprises an energy efficient ethernet (EEE) management logic that is configured to:
monitor a network for changes in topology;
determine that an EEE-enabled device has been added to the network;
record a connection between the EEE-enabled device and one or more network devices;
monitor the connection between the EEE-enabled device and the one or more network devices;
determine the connection is with a latency-sensitive network device; and
modify at least one EEE operation.

16. The device of claim 15, wherein the connection is associated a plurality of specific network port of the EEE-enabled device.

17. The device of claim 16, wherein modifying the at least one EEE operation comprises sending a signal to the EEE-enabled device to disable EEE on a plurality of specific network ports.

18. The device of claim 15, wherein the latency-sensitive network device is associated with a ring network.

19. The device of claim 18, wherein the ring network is configured to utilize at least one control loop.

20. A method of managing energy efficient ethernet (EEE) devices on a network, comprising:
establishing a connection with one or more network devices;
establishing EEE operations with the one or more network devices;
monitoring network traffic;
determining a connection with a latency-sensitive network device; and
modifying the EEE operations.
